(19) United States
(12) Patent Application Publication
(10) Pub. No.: US 2020/0173005 A1
(43) Pub. Date: Jun. 4, 2020

(54) METHOD OF COATING A WORKPIECE

(71) Applicant: SAFRAN NACELLES LIMITED, BURNLEY LANCASHIRE (GB)

(72) Inventor: MICHAEL WALLACE, BURNLEY LANCASHIRE (GB)

(21) Appl. No.: 16/613,009

(22) PCT Filed: May 11, 2018
(86) PCT No.: PCT/GB2018/051271

§ 371 Date: Nov. 12, 2019

(30) Foreign Application Priority Data
May 12, 2017 (GB) 1707690.2

(51) Int. Cl. C23C 4/08; C23C 4/131; C23C 4/18; C23C 4/02; F02K 1/54

(52) U.S. Cl. CPC C23C 4/08; C23C 4/131; F02K 1/54; C23C 4/02; C23C 4/18

(57) ABSTRACT

A method of coating a workpiece, including: spray coating at least a portion of a surface of the workpiece with an inert material, to form a protective layer; and densifying the protective layer, to increase the density and decrease the surface roughness of the protective layer.

The present invention relates to a method of coating a workpiece. The present invention also relates to a system for coating a workpiece, and a component of a thrust reverser coated with an inert protective layer.

Various components and objects are coated with protective layers in many industries, including the aerospace industry. For example, coated components may be used in thrust reversers on jet engines.

A thrust reverser is used to redirect the exhaust of a jet engine, and hence change the direction of thrust. Some thrust reversers, including for example PERT (planar exit rear type) thrust reversers, include two fixed beams, and a pair of doors arranged around the beams. Exhaust flow is directed through a channel formed between the doors and the beams, meaning that a number of internal surfaces are exposed to exhaust gasses. These surfaces are referred to as “internal air washed surfaces”. The doors are semi-circular in cross section, extending along a portion of the length of the beams, and are moved towards or away from each other to direct exhaust flow. The internal air washed surfaces should be relatively smooth, to promote the aerodynamic flow of air. The doors and beams may be made from an aluminium alloy.

Sulphur in the hot exhaust of the engine can mix with water to form sulphuric acid. This can attack the substrate material of the air washed surfaces, causing corrosion, which reduces the strength of the component.

One technique for applying a protective coating to reduce corrosion of an aluminium alloy sheet is cladding. However, cladding involves rolling a cladding layer over the aluminium part, and applying pressure and heat. As such, cladding cannot be used with complex and/or contoured machine parts, such as the components of a thrust reverser. Therefore, complex machine parts made of aluminium are typically anodized and coated with a protective paint or polymer to protect against corrosion. The formulation of the paint can be optimised for resistance to corrosion, but the sulphur and water can still diffuse through, and so corrosion persists.

According to a first aspect of the invention, there is provided a method of coating a workpiece, including:
spray coating at least a portion of a surface of the workpiece with an inert material, to form a protective layer; and
densifying the protective layer, to increase the density and decrease the surface roughness of the protective layer.

The method provides an inert coating on a surface of the workpiece, providing a protective layer against corrosion. Spray coating typically provides a rough surface. However, the densifying step provides a smooth finish. The densifying step also reduces the porosity of the protective layer, increasing the resistance to corrosion.

The method does not require further machining, and so can be used to provide protective coatings on pre-machined complex parts, or to treat existing components. The method can be used to coat any suitable surface of any suitable workpiece. For example the method could be used to coat internal air washed surfaces of a thrust reverser, such as a planar exit rear type thrust reverser.

The protective layer may comprise an inert metal. The protective layer may comprise, or consist essentially of, aluminium. The protective layer may comprise substantially pure aluminium. Aluminium is an inert metal that is lightweight, and easily sprayed coated.

The workpiece may be an aluminium alloy, for example an alloy from the 2000 series of aluminium alloys. The workpiece may comprise an aluminium-copper alloy. The aluminium-copper alloy may comprise up to 10 wt % copper. The aluminium-copper alloy may comprise up to or at least 3 wt % copper, up to or at least 5 wt % copper or up to or at least 8 wt % copper. The aluminium-copper alloy may comprise approximately 6 wt % copper.

Spray coating at least a portion of a surface of a workpiece may comprise directing the inert material from a nozzle or outlet to the surface of the workpiece, wherein a distance between the nozzle or outlet and the work piece is at least 10 centimetres and/or up to 40 centimetres, typically up to 30 centimetres. Holding the nozzle or outlet away from the workpiece means that the spraying does not damage the surface of the workpiece, even if the workpiece is formed of a soft material, such as Aluminium, or alloys of Aluminium. The distance between the nozzle or outlet and the workpiece is optimised to minimise the thermal impact, and to give an homogenous coating with a smooth finish.

Spray coating may comprise thermal spraying, for example, wire arc spraying. Densifying may comprise peening, for example shot peening.

The method may further include: after densifying the protective layer, anodizing the surface of the protective layer. The method may further include: coating the anodized surface with a paint or polymer. Anodizing, and optionally coating, e.g. painting, the surface may provide further protection against corrosion, and/or a smooth surface.

After spray coating and densifying, the protective layer may have a surface roughness of at most 3.5 micron Ra, typically at most 3.2 microns. After spray coating and densifying, the protective layer may have a porosity of at most 0.5%, typically at most 0.4%. After spray coating and densifying, the protective layer may have a thickness of at least 100 microns and/or up to 400 microns. Typically, the protective layer may have a thickness of at least 125 microns and/or up to 305 microns. For example, the protective layer may be 150 microns, 200 microns, 250 microns or 300 microns thick.

The at least a portion of a surface of the workpiece spray coated with the inert material may be defined by a boundary, wherein the surface of the workpiece may include one or more recesses or projecting features within the boundary, wherein recesses or projecting features below a threshold size may not be coated with the inert material.

The method may include one or more of the following steps:
prior to spray coating, degreasing at least the portion of the surface of the workpiece that is to be coated; and
prior to spray coating, abrasive blasting at least the portion of the surface of the workpiece that is to be coated.

The step of spray coating may include:
providing a mask on the workpiece, to cover at least a portion of the surface that is not to be coated;
spray coating the at least a portion of the surface of the workpiece; and removing the mask, prior to densifying.

The method may include:
testing the flexibility and/or the surface roughness and/or the thickness of at least one test piece spray coated at the same time as the workpiece, prior to densifying; and/or
testing the flexibility and/or the surface roughness and/or the thickness of at least one test piece spray coated and densified at the same time as the workpiece, after densifying.

The workpiece may comprise a complex part. For example, the workpiece may comprise a component of a thrust reverser, such as a planar exit rear type thrust reverser. The portion of the surface of the workpiece coated with the protective layer may comprise an air wash surface, e.g. an internal air wash surface, of the thrust reverser.

According to a second aspect of the invention, there is provided a system for coating a workpiece, the system comprising: means for spray coating at least a portion of a surface of a workpiece with an inert material, to form a protective layer; and means for densifying the protective layer, to increase the density and decrease the surface roughness of the protective layer.

The system allows new workpieces to be coated, and existing workpieces to be retrofitted with a protective coating. Spray coating typically provides a rough surface. However, the densification provides a smooth finish. The densification also reduces the porosity of the protective layer, increasing the resistance to corrosion.

The means for spray coating at least a portion of a surface of a workpiece may comprise a nozzle or outlet for dispensing the material of the protective layer, wherein a distance between the nozzle or outlet and the work piece is at least 10 centimetres and/or up to 40 centimetres, typically up to 30 centimetres.

The means for spray coating at least a portion of a surface of a workpiece may comprise a thermal sprayer, for example a wire arc sprayer.

The means for densifying the protective layer may comprise a device arranged to peen the protective layer, for example a shot peener.

The system may include means for anodizing the surface of the protective layer, after densification. The system may include means for coating the anodized surface with a paint or polymer.

The system may include one or more of the following: means for degreasing at least the portion of the surface of the workpiece that is to be coated, prior to spray coating; and means for abrasive blasting at least the portion of the surface of the workpiece that is to be coated, prior to spray coating.

The means for spray coating may include means for masking the workpiece, to cover the portion of the surface that is not to be coated; and means for removing the mask, prior to densification.

The workpiece may comprise a complex part. For example, the workpiece may comprise a component of a thrust reverser, such as a planar exit rear type thrust reverser. The portion of the surface of the workpiece coated with a protective layer may comprise an air wash surface of the thrust reverser.

According to a third aspect of the invention, there is provided a component of a thrust reverser comprising, or consisting essentially of, a metal, the component having one or more air wash surfaces, wherein at least a portion of the air wash surface(s) includes a protective inert metal coating.

The metal may be an aluminium alloy. The component may be formed of the metal, e.g. aluminium alloy. The aluminium alloy may be for example an alloy from the 2000 series of aluminium alloys. The aluminium alloy may be an aluminium-copper alloy. The aluminium-copper alloy may comprise up to 10 wt % copper. The aluminium-copper alloy may comprise up to or at least 3 wt % copper, up to or at least 5 wt % copper or up to or at least 8 wt % copper. The aluminium-copper alloy may comprise approximately 6 wt % copper.

The protective inert metal coating provides the component with a high resistance to corrosion.

The protective inert metal coating may be aluminium. The protective inert metal coating may be substantially pure aluminium.

The surface of the protective inert metal coating may be anodized, and/or covered at least partially with a paint or polymer.

The protective inert metal coating may have a surface roughness of at most 3.5 micron Ra, typically at most 3.2 microns. The protective inert metal coating may have a porosity of at most 0.5% typically at most 0.4%. The protective inert metal coating may have a thickness of at least 100 microns and/or up to 400 microns. Typically, the protective layer may have a thickness of at least 125 microns and/or up to 305 microns. For example, the protective layer may be 150 microns, 200 microns, 250 microns or 300 microns thick.

The surface of the component may include one or more recesses, wherein the protective coating does not extend into the recesses.

The at least a portion of the air wash surfaces coated with the protective metal, e.g. aluminium, coating may be defined by a boundary, wherein the air wash surfaces of the component may include one or more recesses or projecting features within the boundary, wherein recesses or projecting features below a threshold size may not be coated with the protective metal, e.g. aluminium, coating.

According to a fourth aspect of the invention, there is provided a thrust reverser comprising at least one component according to the third aspect.

According to a fifth aspect of the invention, there is provided an aircraft engine including a thrust reverser according to the fourth aspect.

According to a sixth aspect of the invention, there is provided an aircraft having an engine according to the fifth aspect.

Embodiments of the invention will now be described, by way of example only, with reference to the accompanying drawings in which:

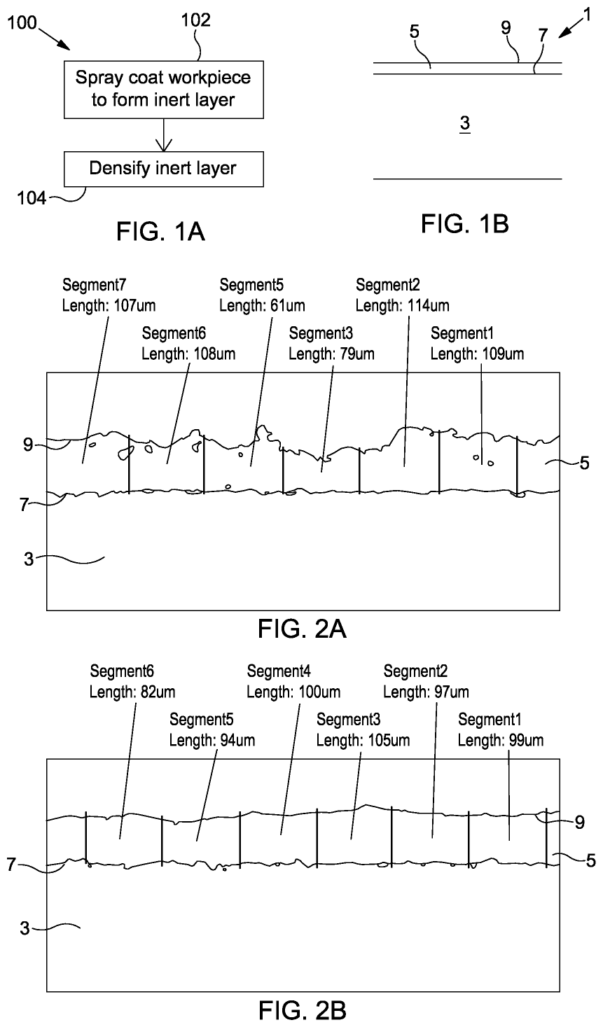

FIG. 1A illustrates a method of coating a workpiece according to a first embodiment of the invention;

FIG. 1B schematically illustrates a workpiece with a protective layer applied according to the method shown in FIG. 1;

FIG. 2A illustrates a cut-through of the protective layer after spray coating;

FIG. 2B illustrates a cut-through of the protective layer after densifying;

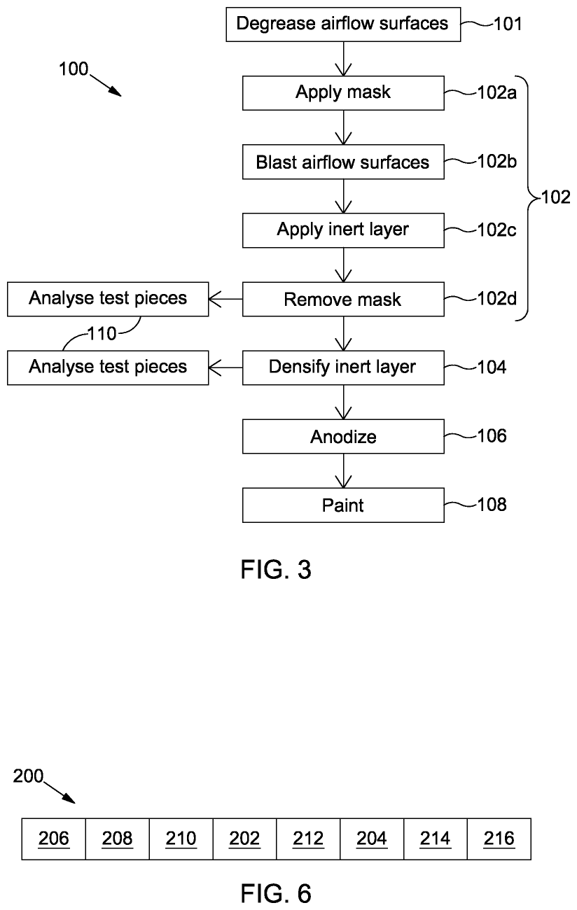

FIG. 3 illustrates a method of coating an air wash surface of a component of a thrust reverser according to an embodiment of the invention;

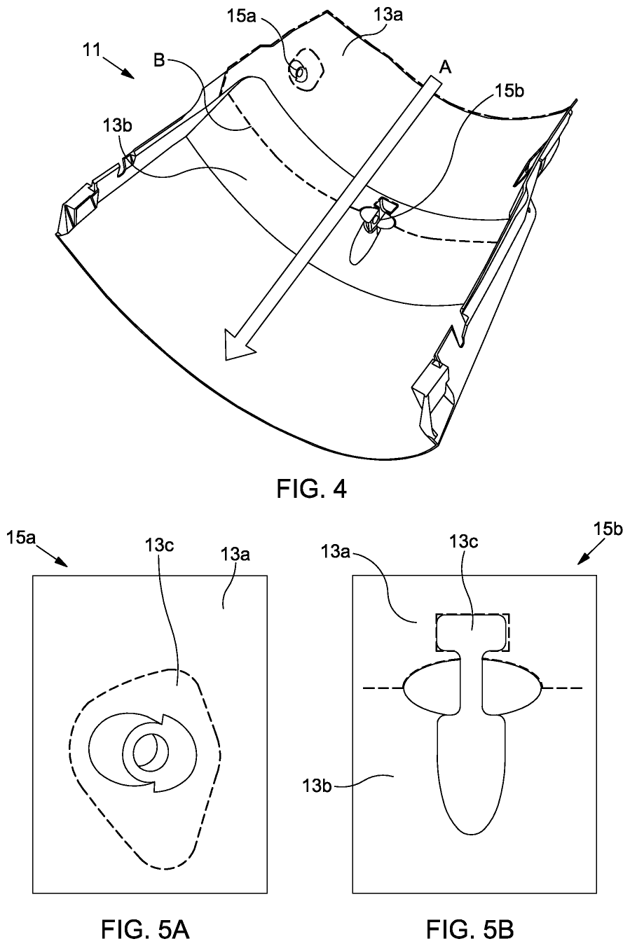

FIG. 4 illustrates the internal surface of a door of a thrust reverser;

FIG. 5A illustrates a first feature on the internal surface of the door of FIG. 2;

FIG. 5B illustrates a second feature on the internal surface of the door of FIG. 2; and

FIG. 6 schematically illustrates a system for coating a door of a thrust reverser, as shown in FIGS. 3 to 5.

FIG. 1A illustrates a method 100 for applying a protective layer (or coating) 5 onto a workpiece 1, shown schematically in FIG. 1B. The protective layer 5 is inert such that it does not react with the substances that it will come into contact with, in use.

The workpiece 1 has a body 3 formed of an aluminium alloy. The body 3 forms a substrate onto which the protective layer 5 is deposited. The body 3 has a surface 7, and in a first step 102, a layer of pure aluminium is spray coated onto this surface 7.

The aluminium is applied using wire arc thermal spraying. In wire arc thermal spraying, an arc is generated between two wires of feed material (in this case Aluminium) by applying an electric charge to each wire. The heat from the arc melts the wire, and the molten aluminium is directed through an outlet or nozzle by a stream of compressed air, or other inert gas.

During spray coating 102, the nozzle or outlet is held around 30 centimetres away from the surface 7 of the workpiece 1. As discussed above, the substrate 3 is formed of an aluminium alloy. The surface 7 of the substrate 3 is relatively soft, as a result of the aluminium content. If the outlet or nozzle is held close to the surface 7, the compressed air stream and molten aluminium may cause damage as it strikes the surface, increasing surface roughness. By holding the nozzle or outlet at least 10 centimetres away from the surface 7, the inert protective layer 5 can be deposited without causing damage, whilst the desired coverage can be achieved by holding the nozzle or outlet at most 40 centimetres away.

The outlet or nozzle is moved over the surface 7 of the workpiece 1 to ensure that the area that requires coating is covered. Alternatively, the workpiece 1 may be moved whilst the nozzle or outlet is held still to achieve the same result. In either case, the movement can be achieved by a suitable automated movement system, such as a robotic arm, or a table or mount which is able to translate in at least one direction.

The wires are pure aluminium, and the inert protective layer deposited is at least 99.5% aluminium, with the remaining material formed by impurities, such that the aluminium can be considered substantially pure.

FIG. 2A shows a cut-through of the workpiece 1 after spray coating 102 of the aluminium layer 5. As shown in FIG. 2A, the surface 9 of the inert protective layer is uneven, with a number of peaks and troughs, and with cavities in the layer 5. In the example shown, the thickness of the aluminium layer 5 is approximately 0.007″+0.002″ (approximately 125 microns to 230 microns), and has a surface roughness of 202μ″ Ra (5.13 microns Ra), and a porosity of 0.6%.

The porosity means that corrosive substances may still pass through the protective layer 5. Also, where the workpiece 1 is to be used in an application requiring a smooth finish, the surface may be too rough.

Therefore, in a second step 104 of the method 100, the protective layer 5 is densified by shot peening. In shot peening, a media (such as round metallic or ceramic particles) is propelled at the surface 9 to be treated to plastically deform the surface 9. The shot can be propelled in a number of ways including air blasts, or centrifugal wheels.

In shot peening, the shot is propelled out of a shot outlet. As with the outlet or nozzle for spray coating, the shot outlet is moved over the surface 9 of the protective layer 5 to ensure that entire layer 5 is peened. Alternatively, the workpiece 1 may be moved whilst the shot outlet is held still, to achieve the same result. As with the spray coating 102, the movement can be achieved by a suitable automated movement system, such as a robotic arm, or a table or mount which is able to translate in at least one direction.

The effect of the shot peening 104 is that the high peaks are removed, and the troughs and cavities filled in, providing a uniform layer of aluminium with low porosity. FIG. 2B shows a cut-through of the workpiece 1 shown in FIG. 2A, after densification. In this example, the protective layer 5 is now approximately 0.007″+0.001″ thick (approximately 150 microns to 200 microns), with a surface roughness Of 91μ″ Ra (2.3 micron Ra) and porosity of 0.3%.

FIG. 3 illustrates an example of how the method 100 of FIG. 1 can be used when the workpiece is a door 11 of a thrust reverser, as shown in FIG. 4. In one example, the thrust reverser may be a planar exit rear type thrust reverser, but it will be appreciated that the method can be applied to any type of thrust reverser. In use, air is directed from a jet engine, along the internal surface of the door, in the direction shown by arrow A. The direction A extends along the beams of the thrust reverser.

The method 100 is used to apply a protective coating 5 to the air wash surfaces of the door 11. In particular, the method 100 may be used to apply a protective coating 5 to the high temperature air wash surfaces 13a, which are the surfaces over which hot air, typically having a temperature above 150° C., moves. The high temperature air wash surfaces 13a are shown in FIG. 4 as the area within the dashed boundary B.

In a first step 101, the internal surface of the door 11 is degreased. After this, the inert layer is sprayed 102 onto the high temperature air wash surfaces 13a. As shown in FIG. 3, spraying 102 includes a number of sub-steps 102a-d.

In a first sub-step 102a, a mask is applied to the internal surface of the door 11. The mask covers areas of the internal surface where the protective layer 5 is not required. As discussed above, in some embodiments, only the high temperature air wash surfaces 13a are to be coated. Therefore, in such embodiments areas of low temperature air wash surfaces areas (are covered by the mask. In some embodiments, an area of the internal surface may be considered a low temperature air wash surface if the air passing over the area of the internal surface during operation is below 150° C. An example of what may in some embodiments be considered a low temperature air wash surface 13b is indicated generally in FIG. 4.

Furthermore, the internal air wash surface 13 may include protrusions and/or recesses 15a, 15b that are too small for the protective layer 5 to be uniformly applied to. FIGS. 5A and 5B show these features in more detail. For example, these features 15a, 15b may be associated with mounting of the door 11 to the beams or the body of the engine the thrust reverser is mounted on, or may be for mounting mechanisms used to move the door 11, or may be for directing air flow.

The mask also covers these small features, to provide further areas 13c where the protective layer 5 is not formed. Therefore, only a portion of the high temperature air wash surface 13a is provided with the protective layer 5.

The mask may cover all of the area where the protective layer is not to be provided. Alternatively, the mask may only cover near the boundary between the region 13a where the protective layer 5 is to be provided and the region(s) 13b, 13c where it is not needed, and the spray coating 102 and densification 104 may be controlled to stay away from the regions 13b, 13c where the protective layer 5 is not needed.

Any suitable mask may be used. For example, the mask may be a tape or barrier layer fixed by adhesive, or a polymer or other chemical coating or barrier layer. Degreasing 101 helps the mask adhere to the surface 13 of the door 11, and also helps the protective layer 5 adhere to the door 11.

After the mask is applied, the areas of the surface where the protective layer 5 is to be formed are blasted 102b, again to help adherence of the protective layer 5. The Aluminium protective layer 5 is then applied 102c by spray coating, as discussed above, and the mask removed 102d.

The densification step 104 is carried out after the mask is removed. This means that both the surface 9 of the protective layer 5 and the surface 13b without a protective layer is densified, and smoothed. This can improve the aerodynamic behaviour of the entire surface 13 of the door 11, not just the region 13a with the protective layer 5.

Finally, the whole of the door 11, including both the surface 9 of the protective layer 5 and the surface 13b without a protective layer is anodised 106, e.g. by tartaric sulphuric anodising or any other suitable anodising technique, and painted 108 with a primer and paint. Again, this can improve the aerodynamic behaviour of the entire surface 13 of the door 11, not just the region 13a with the protective layer 5.

Optionally, test pieces may be processed alongside the door 11. The method 100 may include testing 110 the test pieces for bend tests (testing the flexibility of the protective layer 5), thickness measurement, surface roughness measurement, porosity measurement and quality control. These tests may occur after the spraying 102 is completed, and/or after the densification 104. Some of the tests carried out may be destructive, so it is not appropriate to carry out the tests on the door 11.

The method 100 may be applied to both doors 11 of the thrust reverser, and to the beams. The method 100 may be applied to any component of a thrust reverser.

In one example, the method 100 may be used in a production line, when manufacturing new components for thrust reversers. The production line may include a system 200, shown schematically in FIG. 6, for coating a component of a thrust reverser such as a door 11, as discussed in relation to FIGS. 3 to 5.

The system 200 includes a wire arc spray module 202, and a shot peening module 204, for spraying 102 and densifying the protective layer 5. The system 200 may also include a degreasing module 206, a masking module 208, a blasting module 210, a de-masking module 212, an anodizing module 214, a painting module 216. The modules 202, 204, 206, 208, 210, 212, 214, 216 will operate to implement the methods 100 discussed above.

In one example, the modules 202, 204, 206, 208, 210, 212, 214, 216 may be arranged along a conveyor other line that is used to move the door 11 between the different modules 202, 204, 206, 208, 210, 212, 214, 216. In yet further examples, other means may be provided to move the door between the different modules 202, 204, 206, 208, 210, 212, 214, 216, such as a robotic arm. In alternative examples, the modules 202, 204, 206, 208, 210, 212, 214, 216 may be arranged to work without having to move the door 11 between different stations.

The system 200 is given by way of example only, and any suitable system may be used.

The method 100 may also be applied to treat doors 11 and beams of thrust reversers already in service. The doors and beams can be removed for maintenance, and the method 100 may be carried out as part of the maintenance process. The system of FIG. 6 may be used for this purpose, or a separate apparatus or system may be used,

The method 100 discussed above can be used for doors 11 and beams in any thrust reverser. The method 100 may have applicability in thrust reversers used in smaller aircraft such as business jets, which are typically used for transporting small groups of people (5 or fewer passengers).

It will be appreciated that although the method 100 in FIG. 3 is discussed in relation to a door 11 of a thrust reverser, the steps of FIG. 3 may be used to coat any suitable workpiece 1, for use in a jet engine or any other situation where a protective layer 5 is required.

Whilst it will be appreciated that the method 100 can be used in conjunction with any workpiece 1, it will also be appreciated that the method has particular applicability where the workpiece is a complex part or complex machine part. A complex part is a part having an irregular and/or complicated shape with a number of different protruding or recessed features, with a surface that changes direction and/or includes a number of different surfaces extending in different directions. Alternatively, a complex part may be a part with a machined surface, or a contoured surface. These parts may have already been formed by machining, additive manufacture, or other processes. The method 100 has particular applicability for these complex parts because the protective layer 5 cannot be applied by cladding processes, and the part cannot be re-machined once it is formed.

In the example discussed above, the densified protective layer 5 has a thickness of 0.007″+0.001″ (approximately 150 microns to 200 microns), a surface roughness of 91μ″ Ra (2.3 micron Ra) and porosity of 0.3%. It will be appreciated that these parameters are given by way of example only.

The methods 100 discussed above may be used to provide a protective layer 5 of at least approximately 0.004″ thick (approximately 100 microns). The layer may be up to approximately 0.016″ thick (approximately 400 microns).

The methods 100 discussed above may be used to provide a surface roughness of less than 140μ″ Ra (approximately 3.5 microns Ra).

The methods 100 discussed above may be used to provide a porosity of less than 0.5%.

Typically, the protective layer 5 may be between approximately 0.005″ thick (approximately 125 microns) and approximately 0.012″ thick (approximately 305 microns). Typically, the surface roughness may be less than 125p″ Ra (approximately 3.2 microns Ra). Typically, the porosity may be less than 0.4%.

The degreasing step 101 and/or the blasting step 102b are optional any may be omitted. Similarly, the testing steps 110, and anodizing 106 and painting 108 are also optional and may be omitted.

Furthermore, the masking 102a and de-masking 102d are not required, and any suitable means may be employed so that only certain areas of the workpiece 1 are selectively coated.

In the above examples, the workpiece 1 and/or sprayer or shot peening device are mechanically moved in order to ensure full coverage of the protective layer 5. It will be appreciated that this is by way of example only, and hand held tools may also be used.

In the above example, the inert protective layer is pure Aluminium. It will be appreciated that any suitable inert material may be used. The material should also be able to withstand the temperatures that the workpiece 1 will experience, in use. In other example, other inert metals or other inert materials may be used.

Similarly, although the above example describes the substrate as an aluminium alloy, the substrate may be any material. For example, any other alloy of aluminium, or any other metals or alloys may be used.

Wire arc spraying is just one example of a method that could be used to apply the inert material 5. Other thermal spraying techniques could also be used, such as plasma spraying, flame spraying, high velocity oxy-fuel coating spraying are also applicable. In some examples, spraying methods other than thermal spraying may be used.

Similarly, shot peening is just one method of densifying a surface layer that could be used. Other techniques that could be used include laser peening and high frequency impact treatment.

Similarly, any suitable anodizing and/or coating, e.g. painting, process may be used.

1. A method of coating a workpiece, including:
spray coating at least a portion of a surface of the workpiece with an inert material, to form a protective layer; and
densifying the protective layer, to increase the density and decrease the surface roughness of the protective layer.

2. The method of claim 1, wherein the protective layer comprises an inert metal.

3. (canceled)

4. The method of claim 1, wherein the workpiece comprises an aluminium alloy.

5. The method of claim 1, wherein spray coating at least a portion of a surface of a workpiece comprises directing the inert material from a nozzle or outlet to the surface of the workpiece, wherein a distance between the nozzle or outlet and the work piece is at least 10 centimetres and/or up to 40 centimetres.

6. The method of claim 1, wherein spray coating comprises thermal spraying.

7. (canceled)

8. The method of claim 1, wherein densifying comprises peening.

9. The method of claim 1, further including:
after densifying the protective layer, anodizing the surface of the protective layer.

10. (canceled)

11. The method of claim 1, wherein after spray coating and densifying:
the protective layer has at least one of a surface roughness of at most 3.5 micron Ra,
a porosity of at most 0.5%, or
a thickness of at least 100 microns and/or up to 400 microns.

12. The method of claim 1 including one or more of the following steps:
prior to spray coating, degreasing at least the portion of the surface of the workpiece that is to be coated; and
prior to spray coating, abrasive blasting at least the portion of the surface of the workpiece that is to be coated.

13. The method of claim 1 including:
providing a mask on the workpiece, to cover at least a portion of the surface that is not to be coated;
spray coating the at least a portion of the surface of the workpiece; and
removing the mask, prior to densifying.

14. The method of claim 1 including:
testing the flexibility and/or the surface roughness and/or the thickness of at least one test piece spray coated at the same time as the workpiece, prior to densifying; and/or
testing the flexibility and/or the surface roughness and/or the thickness of at least one test piece spray coated and densified at the same time as the workpiece, after densifying.

15. A system for coating a workpiece, the system comprising:
means for spray coating at least a portion of a surface of a workpiece with an inert material, to form a protective layer; and
means for densifying the protective layer, to increase the density and decrease the surface roughness of the protective layer.

16. The system of claim 15, wherein the system is arranged to perform the method of claim 1.

17. The method of claim 1, wherein the workpiece comprises a complex part, and/or the workpiece comprises a component of a thrust reverser, and optionally the portion of the surface of the component of the thrust reverser coated with the protective layer comprises an internal air wash surface.

18. A component of a thrust reverser comprising, or consisting essentially of, a metal, the component having one or more air wash surfaces, wherein at least a portion of the air wash surface(s) includes a protective inert metal coating.

19-21. (canceled)

22. The component of claim 18, wherein:
the inert metal coating has at least one of a surface roughness of at most 3.5 micron Ra,
a porosity of at most 0.5%, or
a thickness of at least 100 microns and/or up to 400 microns.

23. A thrust reverser comprising at least one component according to claim 18.

24. An aircraft engine including a thrust reverser according to claim 23.

25. An aircraft including an engine according to claim 24.

26. The system of claim 15, wherein the workpiece comprises at least one of a complex part or a component of a thrust reverser.
